(19) United States
(12) Patent Application Publication
(10) Pub. No.: US 2013/0086279 A1
(43) Pub. Date: Apr. 4, 2013

(54) SYSTEMS AND METHODS FOR MEDIA SERVICE DELIVERY

(71) Applicant: Avvasi Inc., Waterloo (CA)

(72) Inventors: Michael Archer, Cambridge (CA); Michael Gallant, Kitchener (CA); Kevin Goertz, Waterloo (CA); Anthony Joch, Waterloo (CA); Roman Czeslaw Kordasiewicz, Elmira (CA); Jim Kuhn, Waterloo (CA); Roxsan Payette, Ariss (CA); Charles Neville Samuell, Toronto (CA)

(73) Assignee: AVVASI INC., Waterloo (CA)

(21) Appl. No.: 13/631,366

(22) Filed: Sep. 28, 2012

Related U.S. Application Data
(60) Provisional application No. 61/541,046, filed on Sep. 29, 2011.

(51) Int. Cl. G06F 15/16

(52) U.S. Cl. 709/233

(57) ABSTRACT

Methods and systems for delivering multimedia content in various telecommunications networks while optimizing quality of experience (QoE). The described methods and systems implement a fast processing path and a slow processing path. In the fast processing path, minimal packet processing is performed to reduce latency. In the slow processing path, increased packet processing is performed to identify media sessions and to perform further data processing. The slow processing path can be used in an online or offline mode, depending on a current flow state.

### CROSS-REFERENCE TO RELATED APPLICATIONS

This application claims the benefit of U.S. Provisional Patent Application No. 61/541,046, entitled “Method and System for IP Video Service Delivery”, filed Sep. 29, 2011. The entire contents of U.S. Provisional Patent Application No. 61/541,046 are hereby incorporated by reference.

### FIELD

The described embodiments relate to the delivery of media service and, in particular, to the delivery of media service via a data network.

### BACKGROUND

Streaming multimedia content from various multimedia sources over various computer networks is becoming increasingly popular. Streaming has become an important element of the “Internet” experience through media providers such as YouTube™, Netflix™ and many others. Due to growing demands for streaming multimedia content, modern mobile data networks require an increasingly large amount of bandwidth.

Multimedia services geared towards real-time entertainment contribute significantly to the amount of traffic on many networks and impose significant load for the organizations that provide those networks and distribute the media content. Network operators and multimedia content providers and distributors are limited in their ability to optimize media traffic and tune individual media sessions in order to balance the overall quality of experience and network utilization. This may result in bandwidth shortages and degraded user experiences.

### SUMMARY

In a broad aspect, there is provided a method of optimizing data traffic destined for an external computing device in a network, the method comprising: receiving data destined for the external computing device from the network; identifying a selected media session in the received data; processing the selected media session; and transmitting the processed selected media session data to the external computing device via the network.

The method may further comprise processing the received data in a fast path; determining a current flow state; if a current flow state indicates that further processing of the received data is to be performed, processing the data in a slow path, wherein the processing the data in the slow path identifies the selected media session.

In some cases, the selected media session is processed in accordance with at least one policy. In some cases, the policy is a media session policy. In some cases, the policy is a location policy. In some cases, the policy is applied dynamically during a lifetime of the selected media session. In some cases, the slow path processing is performed inline.

The method may further comprise timing the identifying of the selected media session, wherein, if a timeout period is not exceeded, the selected media session is processed and transmitted, and wherein, if the timeout period is exceeded, the selected media session is not processed and the received data is transmitted to the external computing device via the network.

In some cases, the fast path processing comprises packet marking after processing the selected media session data and prior to transmitting the processed selected media session data.

In some cases, the fast path processing comprises packet shaping or policing after processing the selected media session data and prior to transmitting the processed selected media session data.

In some cases, the data is intersected in a bump-in-the-wire configuration.

The method may further comprise, prior to identifying the selected media session, load balancing between a plurality of packet processing elements to identify a packet processing element to process the received data.

In some cases, the load balancing is based on an IP address of the external computing device. In some cases, the load balancing is based on a location of the external computing device.

The method may further comprise estimating a traffic load of at least one network domain associated with the external computing device. In some cases, the estimated traffic load is based on an available network bandwidth in the at least one network domain.

In some cases, an optimization applied when processing the selected media session is determined based at least on the estimated traffic load of the at least one network domain.

The method may further comprise generating a real-time network model of the traffic load and capacity based on monitoring of a status of the at least one network domain.

In some cases, an optimization applied when processing the selected media session comprises transcoding the input media stream.

In some cases, the transcoding of the input media stream is performed in parallel by a plurality of transcoding processors. In some cases, at least one transcoding parameter for optimization is selected in order to achieve a device target QoE.

In some cases, the input media stream is an adaptive stream, and wherein an optimization applied when processing the selected media session comprises controlling an operating point of the adaptive media stream.

In some cases, the optimization comprises applying an access control.

In some cases, the selected media session is processed to comprise an alternative media stream.

In some cases, an optimization applied when processing the selected media session comprises remultiplexing the input media stream.

In another broad aspect, there is provided an apparatus for optimizing data traffic in a network, the apparatus comprising: a memory; a network interface; and at least one processor communicatively coupled to the memory and the network interface, the processor configured to carry out a method as described herein.

In another broad aspect, there is provided a system for optimizing data traffic in a network, the system comprising: a switch element configured to receive data destined for the external computing device from the network; a packet processing element configured to: identify a selected media session in the received data; process the selected media session; and wherein the switch element is further configured to transmit the processed data to the external computing device via the network.

In some cases, the packet processing element comprises: a fast path module configured to process the received data and determine a current flow state; and a slow path module configured to process the data to identify the selected media session if the current flow state indicates that further processing of the received data is to be performed.

In some cases, the selected media session is processed in accordance with at least one policy. In some cases, the policy is a media session policy. In some cases, the policy is a location policy. In some cases, the policy is applied dynamically during a lifetime of the selected media session. In some cases, the slow path processing is performed inline.

In some cases, the system is further configured to time the identifying of the selected media session, wherein, if a timeout period is not exceeded, the selected media session is processed and transmitted, and wherein, if the timeout period is exceeded, the selected media session is not processed and the received data is transmitted to the external computing device via the network.

In some cases, the fast path processing comprises packet marking after the selected media session data is processed and prior to transmission of the processed selected media session data.

In some cases, the fast path processing comprises packet shaping after the selected media session data is processed and prior to transmission of the processed selected media session data.

In some cases, the data is intersected in a bump-in-the-wire configuration.

In some cases, the switch element comprises a load balancer configured to load balance between a plurality of packet processing elements to identify a packet processing element to process the received data.

In some cases, the load balancing is based on an IP address of the external computing device. In some cases, the load balancing is based on a location of the external computing device.

The system may further comprise a control element, wherein the control element is configured to estimate a traffic load of at least one network domain associated with the external computing device.

In some cases, the estimated traffic load is based on an available network bandwidth in the at least one network domain.

In some cases, an optimization applied when processing the selected media session is determined based at least on the estimated traffic load level of the at least one network domain.

In some cases, the control element is configured to generate a real-time network model of the network based on monitoring of a status of the at least one network domain.

In some cases, an optimization applied when processing the selected media session comprises transcoding the input media stream. In some cases, the transcoding of the input media stream is performed in parallel by a plurality of transcoding processors. In some cases, at least one transcoding parameter is selected in order to achieve a device target QoE.

In some cases, the input media stream is an adaptive stream, and wherein an optimization applied when processing the selected media session comprises controlling an operating point of the adaptive media stream.

In some cases, the optimization comprises applying an access control.

In some cases, the selected media stream is processed to comprise an alternative media stream.

### BRIEF DESCRIPTION OF THE DRAWINGS

Preferred embodiments of the present invention will now be described in detail with reference to the drawings, in which:

FIG. 1 is a block diagram of a media service gateway in accordance with an example embodiment;

FIG. 2A is an example implementation of a mobile data network in accordance with the system of FIG. 1;

FIG. 2B is another example implementation of a mobile data network in accordance with the system of FIG. 1;

FIG. 3 is a simplified block diagram of a media service gateway in accordance with the system of FIG. 1; and

FIG. 4 is an example process flow that may be followed by the media service gateway of FIG. 3.

The drawings, described below, are provided for purposes of illustration, and not of limitation, of the aspects and features of various examples of embodiments described herein. The drawings are not intended to limit the scope of the teachings in any way. For simplicity and clarity of illustration, elements shown in the figures have not necessarily been drawn to scale. The dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g. ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

The described embodiments may generally provide systems and methods to control access to a multimedia stream in a streaming session to manage multimedia traffic in wired and wireless communication networks and to perform traffic optimization. Traffic optimization is an ongoing process that includes a configurable set policy rules defined by a policy language that express operator preferences, goals to achieve, and constraints to operate within; a continuous feedback loop that monitors individuals and overall QoE, bandwidth availability, and congestion status; access control (initial resource selection) based on device capabilities, hardware resource availability, local policies, and congestion status; and the ongoing tuning of individual media session using such real-time collected metrics.

The embodiments described herein may be used in conjunction with systems and methods for providing congestion estimation in a communications network, which can be found, for example, in co-pending U.S. application Ser. No. 13/053,565, the entire content of which is hereby incorporated by reference. The embodiments described herein may also be used in conjunction with systems and methods for estimating Quality of Experience (QoE) of media streams, which can be found, for example, in co-pending U.S. application Ser. No. 13/053,650, the entire content of which is hereby incorporated by reference.

Quality of Experience may be defined as how a user perceives a service when in use. QoE may be measured subjectively or modeled. If modeled, the model may generate a score which is an estimate of a subjective score. In the case of automated QoE measurement, a device may implement one or more models which generate QoE scores for media sessions identified in network traffic.

QoE scores may reflect the impact of one or more of the delivery network, source content, and display device on the user experience during a media session. Network effects may manifest as temporal artifacts such as startup delay, re-buffering, unexpected stream switching, etc. Content effects may manifest as spatial artifacts in the content such as blurring, blocking, noise, etc. Device effects generally include display size.

Network operators and multimedia content providers and distributors are limited in their ability to control access of multimedia streams by subscribers or users. This may result in bandwidth shortages and degraded user experiences.

Methods and systems are described herein for delivering multimedia content in various telecommunications networks in a controlled manner. The described methods and systems may attempt to balance overall QoE and network utilization metrics for all users in a particular location. In particular, the described methods and systems may reduce cost while preserving QoE as perceived by end users, or by reducing QoE in a controlled, deterministic manner.

Accordingly, network operators can be enabled to increase revenue by preserving QoE or increasing QoE in a controlled manner.

The described methods and systems may take into account subscriber information, transport layer information, application layer information, container layer information, elementary stream information, device information, network location and status information, media site/service information, time of day, QoE information. In some cases, the described methods and systems may operate within a Policy and Charging Control (PCC) architecture and the Policy and Charging Enforcement Function/Application Function (PRCF/AF) role.

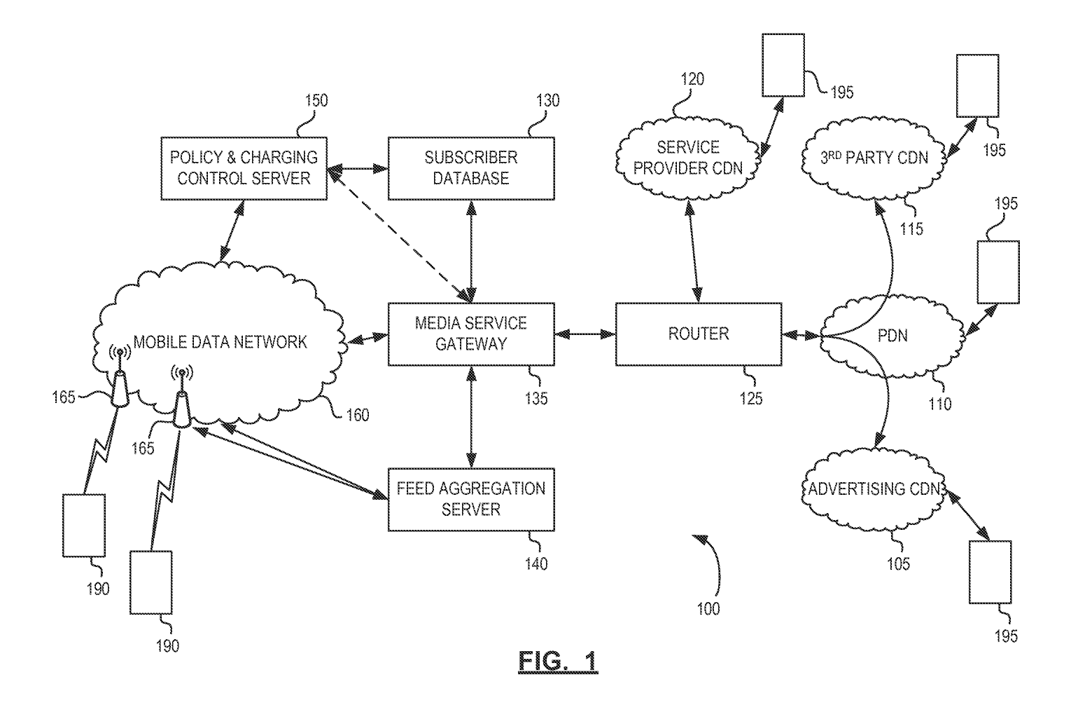

Reference is first made to FIG. 1, illustrating a block diagram of a media service delivery system 100 in accordance with an example embodiment. System 100 generally comprises a media service gateway 135 that interfaces between one or more delivery networks and a mobile data network 160.

Advertising content delivery network (CDN) 105, primary delivery network 110, third party CDN 115, service provider CDN 120, and mobile data network 160 may comprise data networks capable of carrying data, such as the Internet, public switched telephone network (PSTN), or any other suitable local area network (LAN) or wide area network (WAN). In particular, mobile data network may comprise a Universal Mobile Telecommunications System (UMTS), 3GPP Long-Term Evolution Advanced (LTE Advanced) system, Worldwide Interoperability for Microwave Access (WiMAX) system, other 3G and 4G networks, and their equivalent and successor standards.

Mobile data network 160 may comprise a plurality of base transceiver stations 165, which are operable to communicate with individual client devices 190.

Networks 105, 110, 115 and 120 may comprise content delivery networks. In some embodiments, one or more of networks 105, 110, 115 and 120 may be merged or incorporated into one another as part of a single network.

In general, a content delivery network comprises a plurality of nodes. Each node may have redundant cached copies of content that is to be delivered upon request. The content may be initially retrieved from a media server 195 and subsequently cached at each node according to a caching or retention policy.

CDN nodes may be deployed in multiple geographic locations and connected via one or more data links (e.g., backbones). Each of the nodes may cooperate with each other to satisfy requests for content by clients while optimizing delivery. Typically, this cooperation and delivery process is transparent to clients.

In a CDN, client requests for content may be algorithmically directed to nodes that are optimal in some way. For example, a node that is geographically closest to a client may be selected to deliver content. Other examples of optimization include choosing nodes that are the fewest number of network hops away from the client, or which have the highest current availability.

One or more client devices 190 may request media content from media servers 195.

In the illustrated embodiments, client devices 190 may be any computing device, comprising a processor and memory, and capable of communication via a mobile data network. For example, client devices 190 may be a personal or portable computer, mobile device, personal digital assistant, smart phone, electronic reading device, and portable electronic devices or a combination of these. The client device 190 is generally operable to send or transmit requests for media content.

In various embodiments, the client device 190 includes a requesting client which may be a computing application, application plug-in, a widget, media player or other mobile device application residing or rendered on the device 190 in order to send or transmit one or more requests.

Media server 195 may comprise one or more servers equipped with a processor and memory storing, for example, a database or file system. Media server 195 may be any server that can provide access to multimedia content, such as video and audio content in a streaming session by, for example, storing the multimedia content. The content may comprise a wide variety of user-generated content, including movies, movie clips, TV shows, TV clips, music videos, video blogging and short original videos, etc. Examples of media server 195 may include websites such as YouTube™ and Netflix™, etc. Media server 195 may also store a plurality of versions of the same multimedia content, such as, for example, different formats or resolutions of the same multimedia content. For example, a media server may store the same movie clip in two or more video resolutions, such as 480p, 720p, 1080i or 1080p. Likewise, the media server may store the same movie clip in two or more video formats, such as Windows Media Video or Moving Picture Experts Group MPEG-4 Advanced Video Coding (MPEG-4 AVC).

Generally, a media server 195 is operable to commence a media streaming session in response to a request for multimedia content from a client device 190, as described further herein. The request may traverse mobile data network 160 and be relayed to media service gateway 135. Media service gateway 135 may deny the request, modify it, or transmit it further to the respective media server 195 via a router 125, which connects to a suitable network for delivering the request. In some embodiments, router 125 may be incorporated into media service gateway 135, or into one or more of networks 105, 110, 115 or 120.

Media service gateway 135 may be a server system equipped with a processor and memory storing, for example, a database or file system. Although only one media service gateway 135 is shown for clarity, there may be multiple media service gateways 135 distributed over a wide geographic area and connected via, for example, a data network such as service provider CDN 120. Media service gateway 135 may further comprise a network interface for connecting to the data networks comprising system 100. In some embodiments, media service gateway 135 may be incorporated into a hardware router 125, as a software module, for example.

In addition, system 100 may comprise a policy and charging control (PCC) server 150, a subscriber database server 130 and a feed aggregation server 140, as described further herein.

Although the exemplary embodiments are shown primarily in the context of mobile data networks, it will be appreciated that the described systems and methods are also applicable to other network configurations. For example, the described systems and methods could be applied to data networks using satellite, digital subscriber line (DSL) or data over cable service interface specification (DOCSIS) technology in lieu of, or in addition to a mobile data network.

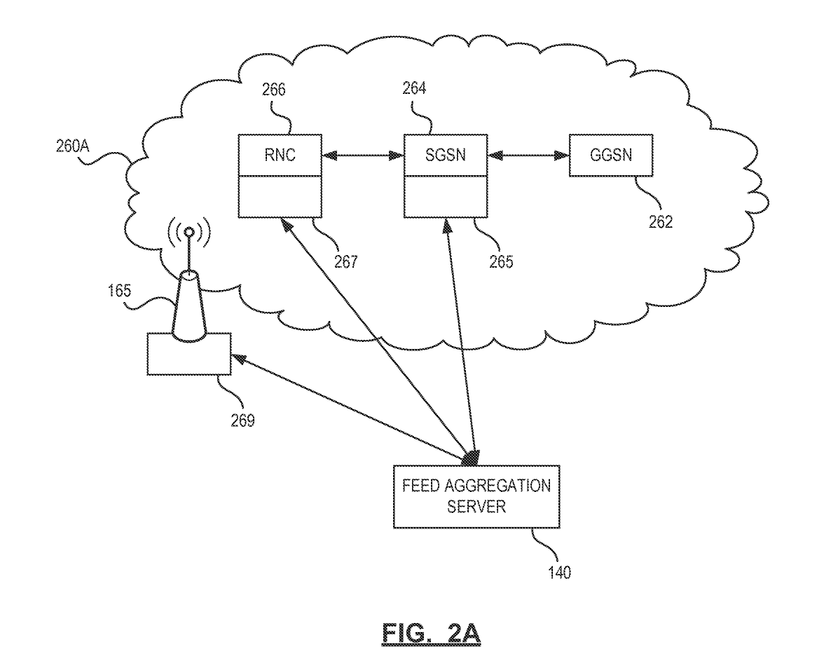

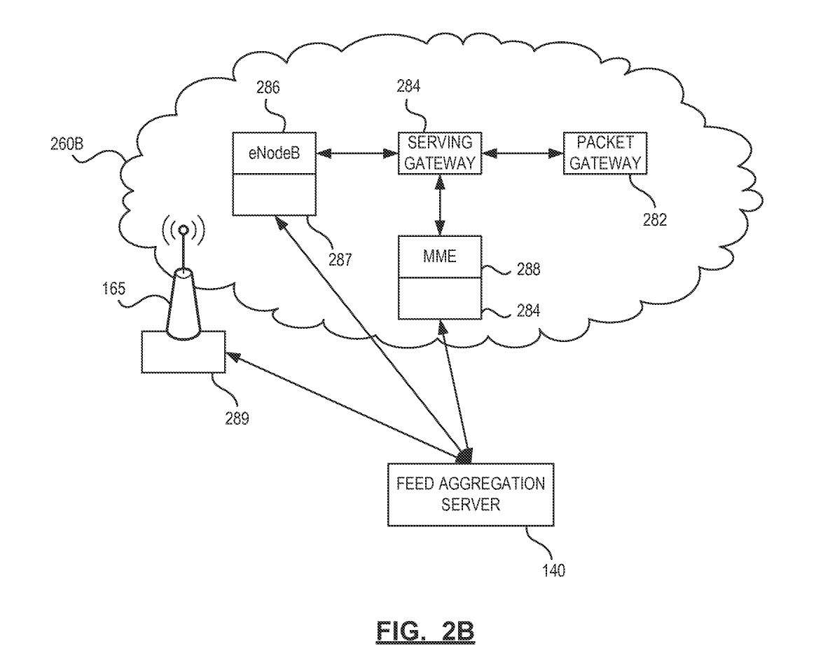

Referring now to FIGS. 2A and 2B, there are shown example implementations of a mobile data network in system 100.

Referring to FIG. 2A in particular, there is illustrated a mobile data network 260A, which may be a “3G” implementation of mobile data network 160 using a standard such as Universal Mobile Telecommunications System (UMTS).

Mobile data network 260A comprises support nodes including a serving GPRS support node (SGSN) 264 (where GPRS stands for General Packet Radio Service) and a gateway GPRS support node (GGSN) 262. Mobile data network 260A further comprises a radio network controller (RNC) 266. Various other network elements commonly deployed in a 3G mobile data network are omitted for simplicity and clarity.

Each mobile data network 260A may comprise a plurality of support nodes and radio network controllers.

Reference points, node taps and feeds (265, 267 and 269) may be provided for each SGSN 264, RNC 266 and base transceiver station 165, and used to provide input data and statistics regarding, for example, user plane data and control plane data to a feed aggregation server 140. Data may be gathered inline using one or more respective approaches.

Generally, user plane data may be considered to be “payload” data or content, such as media data. Conversely, control plane data may be signaling and control information used during a data communication session.

In a first approach, an inline, full user plane traffic mode may be used (as shown in FIG. 2A), in which full, but separate, user plane and control plane data is monitored and provided to media service gateway 135, for example via feed aggregation server 140. In such an approach, the monitoring may be active in the user plane, but passive in the control plane. One example of control plane monitoring is the use of a Radio Access Network (RAN) data feed 267 to capture and provide signaling information from RNC 266.

The availability of control plane data facilitates better optimization by media service gateway 135, by providing information about device mobility and location, among other things.

In another approach, an inline, partial user plane traffic mode may be used (not shown), in which another inline node (e.g., gateway or deep packet inspection router) redirects a subset of monitored traffic to media service gateway 135. In this approach, control plane data may not be available.

In a further approach, an inline, full and combined user and control plane traffic mode may be used (not shown), in which user and control plane data is monitored and redirected in a combined feed.

Accordingly, input data and statistics may be obtained from the user plane (e.g., content data) or from the control plane used for signaling information with the client device. The monitored data may be in the form of conventional Internet Protocol (IP) data traffic or in the form of tunneled data traffic using a protocol such as Generic Routing Encapsulation (GRE), GPRS Tunnelling Protocol (GTP), etc.

Control plane data may be used to extract data about the client device, including location and mobility, device type (e.g., International Mobile Equipment Identity [IMEI]) and subscriber information (e.g., International Mobile Subscriber Identity [IMSI] or Mobile Subscriber Integrated Services Digital Network Number [MSISDN]). Control plane data may also reveal information about the RAN, including number of subscribers using a particular node, which can be an indicator of congestion.

Referring now to FIG. 2B, there is illustrated a mobile data network 260B, which may be a “4G” implementation of mobile data network 160 using a standard such as 3GPP Long Term Evolution (LTE). Mobile data network 260B is generally analogous to mobile data network 260A, except that network elements with different capabilities may be provided.

Mobile data network 260B comprises gateways including a serving gateway 284, and a packet gateway 282. Mobile data network 260B further comprises an Evolved Node B (eNodeB) 286 and a mobile management entity (MME) 288. Various other network elements commonly deployed in a 4G mobile data network are omitted for simplicity and clarity.

Each mobile data network 260B may comprise a plurality of gateways, eNodeBs and MMEs.

Reference points, node taps and feeds (284, 287 and 289) may be provided for each MME 288, eNodeB 286 and base transceiver station 289, and used to provide input data and statistics to a feed aggregation server 140. Data may be gathered inline using one or more respective approaches as described herein.

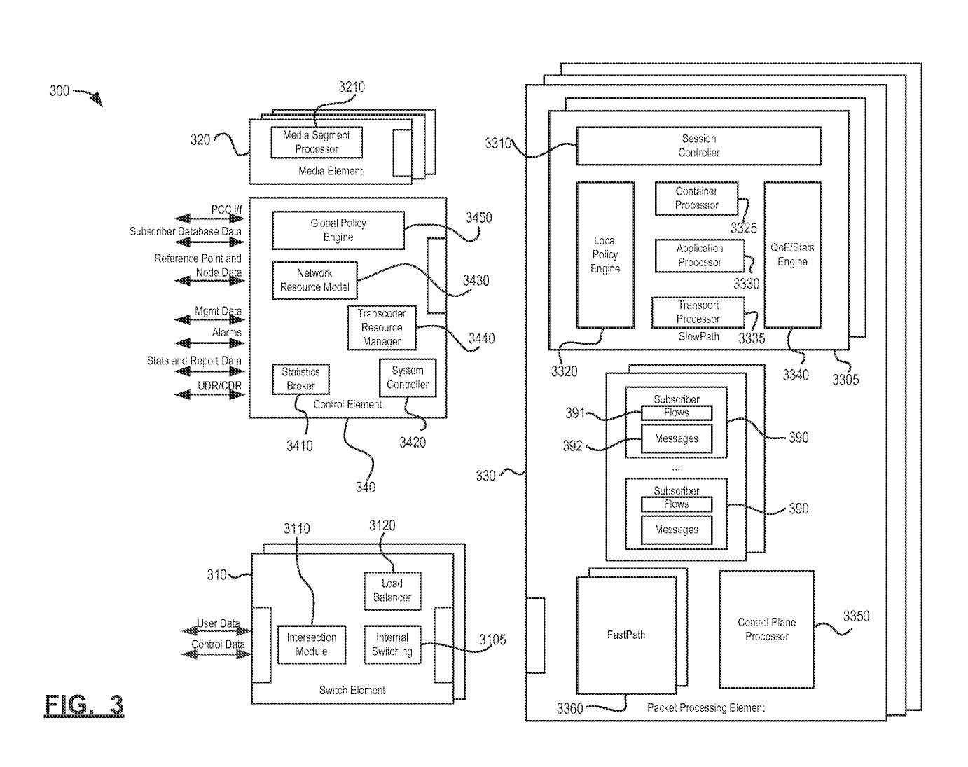

Referring now to FIG. 3, there is illustrated a simplified block diagram of a media service gateway 300, which is an example implementation of media service gateway 135 of FIG. 1.

Media service gateway 300 is generally capable of identifying media sessions in generic network data traffic. Identifying media sessions permits media session-based policy execution and traffic management. This is a significant enhancement over conventional per-flow or per-subscriber application of policy, in which policies are applied to individual flows (per packet or per flow) or applied to all data for a particular subscriber (per subscriber). Media service gateway 335 may be configured to determine and enforce media session-based policies to balance the overall quality of experience (QoE) and network utilization for all users, based on the service provider's policy constraints. Determinations and enforcement can be performed by working in a closed-loop mode, using continuous real-time feedback to optimize and tune individual media sessions. In conjunction with detailed media session analysis and reporting, media service gateway 300 may provide control and transparency to service providers attempting to manage rapidly growing media traffic on their network.

To accomplish this, media service gateway 300 performs a number of functions that would conventionally be implemented via separate interconnected physical appliances. Implementation in an integrated architecture, which supports a wide range of processor options, is beneficial in order to reduce cost while improving performance and reliability. Accordingly, media service gateway 300 may comprise one or more switch elements 310 one or more media processing elements 320, one or more packet processing elements 330, and one or more control elements 340 in an integrated platform. In some embodiments, the function of one or more of switch elements 310, media processing elements 320, packet processing elements 330 and control elements 340 may be integrated, such that a subset of the elements implements the entire functionality of media service gateway 300 as described herein. In some embodiments, one or more of the elements may be implemented as a server “blade”, which can be coupled together via a backplane. Each of the elements may comprise one or more processors and memories.

### Switch Element

Switch elements 310 can generally be considered to provide the external network interface for media service gateway 300. Each switch element 310 may comprise a processor (not shown) configured to perform control and data plane traffic load balancing across packet processing elements 330. Each switch element 310 may further comprise an internal switching module 3105 configured to perform internal control and data plane traffic switching between all elements, and one or more traffic intersection modules 3110, configured to provide most or even all external data input/output for the media service gateway 300. Media service gateway 300 can function with a single switch element 310, however multiple switch elements 310 may be preferred for redundancy.

Each switch element 310 may further comprise one or more load balancers 3120, which may be configured to distribute traffic from a large number of subscribers evenly across one or more packet processing elements 330. This distribution allows high bandwidth links to be processed without overloading any single packet processing element 330. Load balancer 330 may apply filter rules to identify a subset of data traffic (e.g., to the lowest octet of a subscriber's IP address—essentially a 256 bucket hash), which may then be mapped to a specific packet processing element 330. In some embodiments, load balancer 3120 may be configured to re-balance traffic, e.g. in the event of a packet processing blade 330 failure. This also permits load re-distribution, rolling upgrades, and other features which require the temporary transfer of traffic from one packet processor element 330 to another, such as the failure of a packet processing element.

Internal switching module 3105 may transmit and receive data traffic between elements in the media service gateway 300 or between multiple media service gateways.

Intersection module 3110 may enable media service gateway 300 to operate in one or more of a number of intersection modes. These intersection modes can permit passive monitoring of traffic, active management of traffic, or combinations thereof, for example using an appropriate virtual local area network (VLAN) configuration. Intersection module 3110 may operate as a transparent layer 2 network device.

For passive monitoring of traffic, intersection module 3110 may be configured to receive a duplicate packet stream, for example, from a network tap or span port, which is processed and later discarded. Intersection module 3110 may also intersect the packet stream, using a bump-in-the-wire configuration, and place the packets back on the wire unmodified, or make use of the integrated switching capabilities to duplicate the packet stream internally and forward copies of the packets for processing, while returning the originals to the wire immediately. This latter approach can be used to provide extremely low latency processing, which further permits any easy transition of media service gateway 300 from passive monitoring to active traffic management.

For active management, intersection module 3110 may also be configured in a bump-in-the-wire configuration, to forward all packets to one or more packet processing elements 330 where management logic may be applied. In the case of active management, packets forwarded internally for further processing may be modified before being placed back on the wire.

Intersection module 3110 may provide input/output facilities for intersecting multiple data links within a network in a transparent, bump-in-the-wire configuration. A transparent bump-in-the-wire configuration is one wherein packets entering a device on a particular port (representing one side of a single data link) are forwarded to the correct ‘partner’ port (representing the other side of the same physical link) after they have been processed, transparently to other nodes or devices. In order to accomplish this, intersection module 3110 may mark packets when they are received by media service gateway 330 in order to identify the source data link, and the direction. Such internal marking can be reversed or deleted before the respective packets are re-enqueued on the wire. Packets may be internally marked in a number of ways, such as VLAN tags, reversible manipulation of source or destination or both MAC addresses, and adding encapsulation headers (using standard or proprietary protocols). The additional information encoded in the packet marking allows each packet to carry the information necessary to direct it to the correct output port without the need for large amounts of internal storage or complex, time-consuming lookups.

### Media Processing Element

Media processing element 320 may be configured to perform inline, real-time, audio and video transcoding of selected media sessions. Media processing elements 320 may also be configured for an off-line, batch conversion workflow mode. Such an offline mode can be used to generate additional streams for a particular media content item at a variety of bit rates and resolutions as idle resources become available. This can be desirable where a particular media content item is frequently delivered in a variety of network conditions.

Media processing elements 320 may comprise one or more general purpose or specialized processors. Such specialized processors may be optimized for media processing, such as integrated media processors, digital signal processors, or graphics processing units.

Media segment processors 3210 operate on media processing element 320 and may implement individual elementary stream transcoding on a per-segment basis. A segment can be defined as a collection of sequential media samples, which starts at a random access point. Media segment processor 3210 may exchange control and configuration messages and compressed media samples with one or more packet processing elements 330.

Media segment processor 3210 may generally perform bit rate reduction. In some cases, it may be beneficial for media segment processors 3210 to perform sampling rate reduction (e.g., spatial resolution and/or frame rate reduction for video, reducing sample frequency and/or number of channels for audio). In some other cases, it may be beneficial for media segment processors 3210 to perform format conversion for improved compression efficiency, whereby the output media stream being encoded may be converted to a different, more efficient format than that of the input media stream being decoded (e.g., H.264/AVC vs. MPEG-4 part 2).

In some cases, a plurality of media segment processors 3210 may operate concurrently in the same media element 320 to provide multi-stream transcoding. In some other cases, media segment processors 3210 for a single media session may be invoked across multiple hardware resources, for example to parallelize transcoding over multiple cores or chips, or to relocate processing in case of hardware failure. Parallelization may occur at the direction of a session controller 3310 running on packet processing element 330.

In some cases, media streams may be modified to comprise alternative media stream content, such as inserted advertisements or busy notification.

### Packet Processing Element

Packet processing element 330 may be generally configured to analyze the network traffic across all layers of the TCP/IP (or UDP/IP, or other equivalent) networking stack, identify media sessions, and apply policy. To facilitate processing with minimal latency and maximum throughput packet processing workloads may be divided into fast-path 3360 and slow-path 3305 modules, which provide separate threads of execution.

Packet processing can be both CPU intensive and highly variable. The amount of processing required for each packet varies depending on the complexity of the packet and the amount of processing required on the packet in order to implement a desired policy. Using a single thread of execution to process every packet can result in excessive latency for packets that require significant processing and also fails to take advantage of parallelization.

In the described methods and systems, processing can be divided into two (or more) layers, where the base layer can be referred to as a fast-path and one or more additional processing layers can be referred to as a slow-path. The fast-path generally implements a first stage of packet processing which requires only a minimal amount of CPU performance. Packets that do not require advanced processing may be forwarded immediately at this stage and are re-enqueued back to the wire with very low latency. Packets that require greater processing can be forwarded to a slow-path for deeper processing. Slow-path processing can be performed independently or in parallel with the fast-path processing, such that slow-path processing does not block or impede fast-path processing. Multiple slow-path threads can be provided, to take advantage of parallel processing, for example, when using multi-core processors.

Control plane processing may be further delegated to a dedicated control plane processor 3350.

### Fast-Path Module

There may be one or more fast-path modules 3360 per packet processing element 330, each receiving load-balanced traffic, for example from a load balancer 3120. In some cases, a fast-path module 3360 may receive packets from a network interface and forward them to one or more slow-path modules 3305 for further processing. Accordingly, a fast-path module 3360 may distribute processing load evenly across one or more slow-path modules 3305. Fast-path module 3360 may implement a high-performance timer system in order to “time-out” or expire flows and media sessions. Fast-path module 3360 may implement mechanisms to send messages between packet processing modules on the element (e.g., between slow-path modules, fast-path modules, and the control-plane processor). Fast-path module 3360 may find and parse the IP layer (IPv4/IPv6) in each packet, perform IP defragmentation, and associate the packets with their appropriate layer-4 UDP or TCP flows. Processing of packets by fast-path module 3360 may also trigger flow and subscriber lookups or creation.

Fast-path module 3360 may support multiple flow states for each packet direction, such as forward, tee, vee, and drop.

In the forward state, packets are re-enqueued to the network interface for immediate transmission, without processing by slow-path module 3305.

In the tee state, packets are both re-enqueued to the network interface for immediate transmission and copied to a slow-path module 3305 for further processing.

In the vee (hold) state, packets are delivered to a slow-path module 3305 for further processing. After processing, slow-path module 3305 may return one or more packets to fast-path module 3360 to be re-enqueued to the network interface for transmission. Accordingly, in the “vee” or “inline” mode, packets may be considered as being processed “inline”, that is forwarded in modified or unmodified form to the original destination. In some cases, while in the “inline” mode, the media service gateway may switch between a bridging and proxying action on a per flow (and therefore per-media session) basis.

In the drop state, packets are discarded without re-enqueuing to a network interface for transmission or further slow-path module 3305 processing.

Transitions between these states are governed by one or more policies and slow-path module 3305 processing.

Fast-path module 3360 may implement packet marking, governed by policy. Marking is performed to manage network traffic by assigning different traffic priorities to data. Packet marking may be subscriber-based, device-based, location-based or media session-based, for example, wherein all flows belonging to a particular location or to a particular media session may be marked identically. The policy system may support a variety of class-of-service marking technologies, including IP Type of Service (TOS) values, IP Differentiated Services Code Point (DSCP) values, VLAN Priority Code Point (PCP) values, or Multiprotocol Label Switching (MPLS) traffic class values. With each of these technologies, the fast-path module 3360 may be configured to apply a specific Class of Service (COS) for specific subset of traffic.

Fast-path module 3360 may also implement shaping and/or policing, as governed by policy. Shaping and policing are tools to manage network traffic by dropping or queuing packets that would exceed a committed rate. Shaping and/or policing may be subscriber-based, device-based, location-based, or media session-based, for example, wherein all flows belonging to a particular location or to a particular device session may be policed and/or shaped identically. Shaping is typically applied on TCP data traffic, since TCP traffic endpoints (the client and server) will inherently back-off due to TCP flow control features and self-adjust to the committed rate. The fast-path module 3360 may be configured to apply a specific policer or shaper to a specific subset of traffic.

### Control Plane Processor

For deployment in a mobile network, such as networks employing 3GPP GRPS/UMTS, LTE, or similar standards, it may be desirable to determine subscriber and device information, location, as well as other mobility parameters for subscriber, device, and location-based traffic management and reporting purposes. This can be accomplished in part by inspecting control plane messages exchanged between gateways, for example GTP-C (GPRS Tunneling Protocol Control) over the Gn interface, GTPv2 over the S4/S11 or S5/S8 interfaces, and the like, or by receiving mobility information from other network nodes, such as the RNC, MME and the like.

In the case of the former, a control plane processor 3350 running on packet processing elements 330 may receive control plane messages from the fast-path module 3360, parse relevant control-plane messages exchanged between gateways in order to extract and map subscribers and devices to locations, and redistribute this information within the media service gateway 330.

In some cases, the media service gateway 300 can function without control plane information, however device, subscriber, and location-aware features such as congestion estimation and aggregate policies may be negatively affected.

### Slow-Path

As described above, fast-path module 3360 may schedule work across one or more slow-path modules 3305. To load-balance work between the slow-path modules 3305, the fast-path module 3360 may schedule work using a subscriber object or construct 390 in a memory of the packet processing element 330. A subscriber object 390 may identify and characterize all flows 391 and associated work/messages 392 for a given subscriber among a plurality of subscribers. A subscriber object 390 may be thought of as the basic unit of processing for slow-path modules 3305. All messages 392, including packets, to be processed for a given subscriber can be enqueued in the subscriber construct 390 and then scheduled and provided to a slow-path module 3305 based on a load-balancing algorithm designed to minimize latency and maximize throughput. Slow-path module 3305 then de-queues and executes pending messages on an input queue built of subscriber objects 390. Messages 392 typically comprise instructions for executing pending work for a given subscriber construct 390.

Fundamentally, a slow-path module 3305 sends and receives messages to/from a fast-path module 3360. Slow-path module 3305 parses the transport through application layer of received/sent packets, and executes policy on subscriber objects 390, which may include subscriber, device, location or media session analysis and processing, for example.

### Slow-Path—Transport

Within the slow-path module 3305, transport layer processor 3335 may parse the transport layer (e.g., TCP, UDP, etc.) and keep track of when packets are sent and received, including when packets are acknowledged (or lost) by the client, to permit modeling of the client video buffer, for example as described in U.S. application Ser. No. 13/231,497, entitled “Device with video buffer modeling and methods for use therewith”, the entire contents of which are hereby incorporated by reference. Transport layer processors 3335 may also reconstruct the data for the application layer and invoke appropriate application layer processors (e.g., HTTP) by examining incoming data from both directions.

Transport layer processor 3335 may implement transparent intelligent proxy for TCP connections (e.g., to permit selective inline modification of packets) when a flow is in tee or vee state. In addition to the conventional benefits of proxying TCP connections between disparate network segments, being selectively inline decreases the risk of the proxy interacting in detrimental ways with non-standard applications and increases packet processing throughput.

Through transport layer processor 3335 intelligent TCP proxy, slow-path module 3305 may support passive and proxy flow states, and transitioning from passive to proxy state at any point during the lifetime of a flow.

Passive flow states imply that the active TCP proxy is disabled (i.e., incoming packets are forwarded without modification and new packets are not created) even though the payload may undergo further analysis through the rest of slow-path processing.

Proxy flow states imply that a TCP proxy is in effect, that is, that both sides of the proxy act as distinct, intermediate sockets. Generally, packets are consumed by one side of the proxy. The incoming payload may be dropped, modified or left unchanged as described herein. Outgoing payloads are those forwarded to the output side of the proxy, following slow-path module 3305 processing.

### Slow-Path—Application

Application processor 3330 may be configured to operate on certain types of detected application layer content, such as HTTP, RTSP and RTMP. Once the application type has been identified, transport layer processors 3335 may largely delegate subsequent payload parsing to the application layer processors 3330. Application layer processors 3330 may be responsible for identifying and delegating to appropriate session controllers 3310 when media sessions are detected, and for relating flows, characteristic interactions and streams to particular sessions.

A media session may generally be considered to have been identified once sufficient traffic relating to that media session has been observed at the application layer. In most cases, the application layer protocols used for media streaming can generally be identified with the first few bytes of payload. After identifying the application payload, the payload can be parsed to find the media content, if any. This can be performed by dividing the communication into independent interactions, which may correspond to individual request/response pairs. Each interaction is evaluated to determine if the content is streaming media. If the interaction contains streaming media, it is further analyzed to extract media characteristics. Those interactions sharing common media characteristics may be encapsulated into streams. A media session may be a collection of one or more streams.

### Slow-Path—Container

Container processor 3325 may parse, analyze and process media containers such as FLV, MP4, ASF and the like. In some variant embodiments, it may also parse, analyze and process associated metadata such as gzipped content, manifest files, and the like. A container processor 3325 can analyze media containers and associated metadata without producing output, for statistics collection or QoE calculation. A container processor 3325 can also produce a new media container, which may differ from the source container in its format or content, via de-multiplexing, transcoding, and re-multiplexing. A container processor 3325 can also produce new metadata. The decision of whether to analyze or produce a new container can be governed by policy.

Generally, media sessions should be identified relatively soon after the container processor 3325 starts parsing the input container. The amount of input that can be buffered in duration or size can be a limiting factor on how soon a decision is made and whether or not certain policies can be applied. A session identification timer may be used to enforce an upper bound on latency for session identification.

### Slow-Path—Session

Session controller 3310 generally encapsulates all of the state and processing for a media session. It may model, modify, and report on the media session. This includes concepts such as session relation, policy execution, and statistics measurement.

### Slow-Path—Policy Actions

Policy actions which may be supported on a media session include access control (i.e., whether to allow the media session), re-multiplexing, request-response modification, client-aware buffer-shaping, transcoding, adaptive streaming control, in addition to the more conventional per-flow actions such as marking, policing/shaping, and the like. Media session policy actions may be further scoped, that is, applied only to specific sites, devices, resolutions, or constrained, that is, subject to minimum/maximum bit rate, frame rate, QoE targets, resolution, and the like, as defined herein.

Slow-path module 3305 may implement access control, as governed by policy. In situations where network resources are scarce and/or the QoE for the new media session is expected to be poor, an access control policy may deny service to the new media session. In addition to denying a media session, providing some form of notification to the subscriber such as busy notification content may reduce the negative impact of the policy on the subscriber's satisfaction.

Slow-path module 3305 may implement re-multiplexing, as governed by policy. A re-multiplexing policy can convert a media session from one container format to another. This action may be useful to allow for the future possibility of transcoding the media session or to convert the media format to align with the client device's capabilities.

Slow-path module 3305 may implement request-response modification, as governed by policy. Request-response modification may involve modifying either the client request or the response. For example, request-response modification may replace requests for high definition content with similar requests for standard definition content.

Slow-path module 3305 may implement client-aware buffer shaping, as governed by policy. Client-aware buffer shaping uses the client buffer model generated by QoE and statistics engine 3340 to prioritize computing and network resources within media service gateway 300, to ensure smooth playback for all client devices that are served concurrently. For example, if client A has 10 seconds of content in a buffer, client B has 60 seconds of content in a buffer, and client C has 2 seconds of content in a buffer, client-aware buffer shaper may prioritize transmission for client C ahead of transmission for clients A and B, and further prioritize client A ahead of client B.

Slow-path module 3305 may implement transcoding, as governed by policy. When a transcode policy action is selected for the session, the session controller 3310 may perform dynamic control of a transcoder to conform to policy targets and constraints. In some cases, it may further implement a feedback control mechanism for a video transcoder to ensure that the media session achieves targets and constraints set out in the policy engine, such as a transcoded video bit rate, transcoded video QoE, etc. The controller reevaluates its control decisions periodically or when it receives a policy update.

In some cases, the session controller 3310 may support allowing a media session to be initially passed through unmodified, but later transcoded due to changes in policy, network conditions including sector load and/or congestion, or the measured QoE. A transcoder resource manager 3440 of a control element 340 may also be able to move a transcode session from one resource to another, for example if a less loaded resource becomes available. As such, media resources may be allocated by the transcoder resource manager 3440 on a segment basis, rather than for an entire elementary stream.

Slow-path module 3305 may also implement adaptive streaming control, as governed by policy. Adaptive stream control may employ a number of tools including request-response modification, manifest editing, conventional shaping or policing, and transcoding. For adaptive streaming, request-response modification may replace client segment requests for high definition content with similar requests for standard definition content. Manifest editing may modify the media stream manifest files in response to a client request. Manifest editing may modify or reduce the available operating points in order to control the operating points that are available to the client. Accordingly, the client may make further requests based on the altered manifest. Conventional shaping or policing may be applied to adaptive streaming to limit the media session bandwidth, thereby forcing the client to remain at or below a certain operating point.

### Slow-Path—QoE and Stats

The QoE and statistics engine 3340 may generate statistics and QoE measurements for media sessions, may provide estimates of bandwidth required to serve a client request and media stream at a given QoE, and may make these values available as necessary within the system. Examples of statistics that may be generated comprise, e.g., bandwidth, site, device, video codec, resolution, bit rate, frame rate, clip duration, streamed duration, audio codec, channels, bit rate, sampling rate, and the like. QoE measurements computed may comprise, e.g., delivery QoE, presentation QoE, and combined QoE.

The raw inputs used for statistics and QoE measurements can be extracted from the traffic processors at various levels, including the transport, application, and media container levels. For example, in the case of a progressive download over HTTP, the container processor detects the locations of the boundaries between video frames and, in conjunction with the transport processor, determines when entire media frames have been acknowledged by the subscriber device to have arrived. The application processor provides information on which client device is being used, and playback events, such as the start of playback, seeking, and the like.

A primary component of delivery QoE measurement is a player buffer model, which estimates the amount of data in the client's playback buffer at any point in time in the media session. It uses these estimates to model location duration and frequency of stall events.

### Slow-Path—LPE

Local Policy Engines 3320 (LPE) can be deployed on every packet processor element 330 and act as a Policy Enforcement Points (PEP). LPE 3320 sends policy requests to a Global Policy Engine (GPE) 3450 of control element 340 and receives and processes policy responses from the GPE 3450. LPE 3320 may also provide local policy decisions for session controller 3310 and fast-path module 3360 in order to reduce the messaging rate to the GPE 3450.

### Control Element

Control element 340 generally performs system management and (centralized) application functions. System management functions may include configuration and command line interfacing, Simple Network Monitoring Protocol (SNMP) alarms and traps and middleware services to support software upgrades, file system management, and system management functions. Control element 340 generally comprises a processor and memory configured to perform centralized application functions. More particularly, control element 340 comprises a global policy engine 3450, a network resource model module 3430 (NRM), a transcoder resource manager 3440 (XRM), and statistics broker 3410.

Centralization of this processing at control element 340 can be advantageous as, due to load balancing, no single packet processing element 330 generally has a complete view of all sessions within a given location, nor a view of all locations.

### Policy

The media service gateway 300 policy system consists of two main logical entities, a Global Policy Engine 3450 of the control element 340 and a Local Policy Engine 3320 of each slow-path module 3305.

GPE 3450 may act as a Local Policy Decision Point (LPDP) and include a messaging framework to communicate with the LPE 3320, NRM 3430 and XRM 3440. The GPE 3450 may maintain a set of locally configured node-level policies, and other configuration settings, that are evaluated by a rules engine in order to perform active management of subscribers, locations, and media sessions. Media sessions may be subject to global constraints and affected by dynamic policies triggered during session lifetime. Accordingly, GPE 3450 may keep track of live media session metrics and network traffic measurements by communicating with the NRM 3430. GPE 3450 may use this information to make policy decisions both when each media session starts and throughout the lifetime of the media session, as the GPE may adjust polices in the middle of a media session due to changes, e.g. in network conditions, changes in business objectives, time-of-day, etc.

GPE 3450 may utilize device data relating to the identified client device, which can be used to determine device capabilities (e.g., screen resolution, codec support, etc.). The device database may comprise a database such as Wireless Universal Resource File (WURFL) or User Agent Profile (UAProf).

The policies available at media service gateway 300 may be dynamically changed by, for example, a network operator. In some cases, GPE 3450 may access policies located elsewhere on a network. For example, GPE 3450 may gather media session policies based on the 3rd Generation Partnership Project (3GPP) Policy Control and Charging (PCC) architecture eco-system (e.g., with a Policy and Charging Rules Function (PCRF)). In such embodiments, policy system may enforce policy (i.e., carry out a Policy Control Enforcement Function (PCEF) with Application Function (AF), or Application Detection and Control (ADC)).

GPE 3450 may also utilize subscriber information. In some cases, subscriber information may be based on subscriber database data obtained from external subscriber database 130. Subscriber database data may include quotas and policies specific to the user and/or a subscription tier. The subscriber database may be accessed via protocols such as Diameter, Lightweight Directory Access Protocol (LDAP), web services or other proprietary protocols. Subscriber database data may be enhanced with subscriber information available to media service gateway 300, such as a usage pattern associated with the subscriber, types of multimedia contents requested by the subscriber in the past, the current multimedia content requested by the subscriber, time of the day the request is made and location of the subscriber making the current request, etc.

GPE 3450 may be configured through a set of external policies that allow the media service gateway to differentiate between how non-media and media traffic is handled, to admit, reject, or limit the amount of resources used by individual media sessions according to their intrinsic characteristics, to regulate the number of media sessions and control the amount of bandwidth used at the location-level (e.g., site), to regulate the number of media sessions and control the amount of bandwidth used at the network level, to progressively apply more aggressive video optimizations as bandwidth usage and/or congestion level increases for a particular location, to establish quality of experience goals and preferences to guide or constraint the video optimization process when making individual media session decisions, etc.

Non-media traffic policies are generally packet-based or flow-based and can be scoped by subscriber, device, and location. The actions are generally implemented in the fast-path module 3360, although configuration and control of the action may occur in slow-path module 3305. Actions may include permit, mark, shape, police, and drop, and may be applied to individual flows or aggregates of flows.

The permit action is the default, passive action, which simply re-enqueues packets to the wire. The mark action applies specific TOS (precedence) or DSCP (AF class) markings to matching flows. The shape action queues packets above a committed per-flow rate. The police action drops packets above a committed per-flow rate. The drop action is a continuous action, to drop all packets that follow, from matching flows, and may be initiated mid-flow.

Media session policies comprise access control, re-multiplexing, request-response modification, client-aware buffer-shaping, transcoding, adaptive streaming control, in addition to the more conventional per-flow actions such as marking, policing/shaping, etc., as described herein.

Media session policy actions may be further scoped or constrained by one or more individual or aggregate media session characteristics, such as:
subscriber (IMEI, IMSI, MSISDN, IP address), subscriber tier, roaming status;
transport protocol, application protocol, streaming protocol;
container type, container meta-data (clip size, clip duration);
video attributes (codec, profile, resolution, frame rate, bit rate);
audio attributes (codec, channels, sampling rate, bit rate);
device type, device model, device operating system, player capabilities;
network location, APN, location capacity (sessions, media bandwidth, delivered bandwidth, congested status);
traffic originating from a particular media site or service, genre (sports, advertising);
time of day; and
QoE metric (PQS, DQS).

A by-product of location-based and media-session based policy is that location- and session-related measurements, such as bandwidth usage, QoE measurements, transcoding efficiency measurements, and network congestion status need to be continuously computed and made available in real-time for the timeliness of policy decisions. Media service gateway 300 may implement these functions through the Network Resource Model 3430 (NRM).

The NRM 3430 may implement a hierarchical subscriber and network model and load detection system that receives location and bandwidth information from packet processor elements 330 or from external network nodes, such as RAN probes, to generate and update a real-time model of the state of a mobile data network 160, in particular congested domain, e.g. sectors. The network model may be based on data from at least one network domain, where the data may be collected by feed aggregation server 140 using one or more node feeds or references points. The NRM may implement a location-level congestion detection algorithm using measurement data, including location, RTT, throughput, packet loss rates, windows sizes, and the like from packet processor elements 330. The NRM 3430 may then provide the GPE 3450 with the currently modeled cell load for one or more cells.

NRM 3430 may also receive per-session statistics such as session bandwidth utilization and quality metrics from packet processor elements 330 for ongoing session tuning and aggregate limit control. It may also receive updates from a control plane processor 3350 to enable mapping subscribers and associated traffic and media sessions to locations.

The XRM 3440 may cooperate with GPE 3440 to allocate media segment processors 3210 from the pool of media processors available in the system, and to identify the available transcoding capabilities to other elements of media gateway system 300, in terms of supported configurations and expected bitrate and quality levels. Resource allocation function may fulfill requests from the GPE 3450 for transcoding resources and manages the status of the media processors. It may determine free media processors when a session is complete, receive updates on the state of the media processors and make determinations about turning on or off processors.

XRM 3440 maintains information about the media processing capabilities of the media processors, and available software versions, and can be configured to advertise these capabilities to other elements of media gateway system 300. It may have a role in deciding appropriate transcoding configurations, both initially and dynamically throughout a session.

System controller 3420 may be configured to perform system management functions including configuration and operational control via command line interface (CLI), generation and transmission of SNMP alarms and traps, implementation of middleware services to support software upgrades, file system management, and other system management functions.

Statistics broker 3410 may be configured to generate and output statistics and report data, such as call data records (CDR) or user data records (UDR) regarding the operation of media service gateway 300 to a remote device. Reported data may include data such as transcoding resolutions, bitrates, etc. Additional reported data may include data used by an analytics engine as described in co-pending U.S. patent application Ser. No. 13/191,629, the entire contents of which are hereby incorporated by reference.

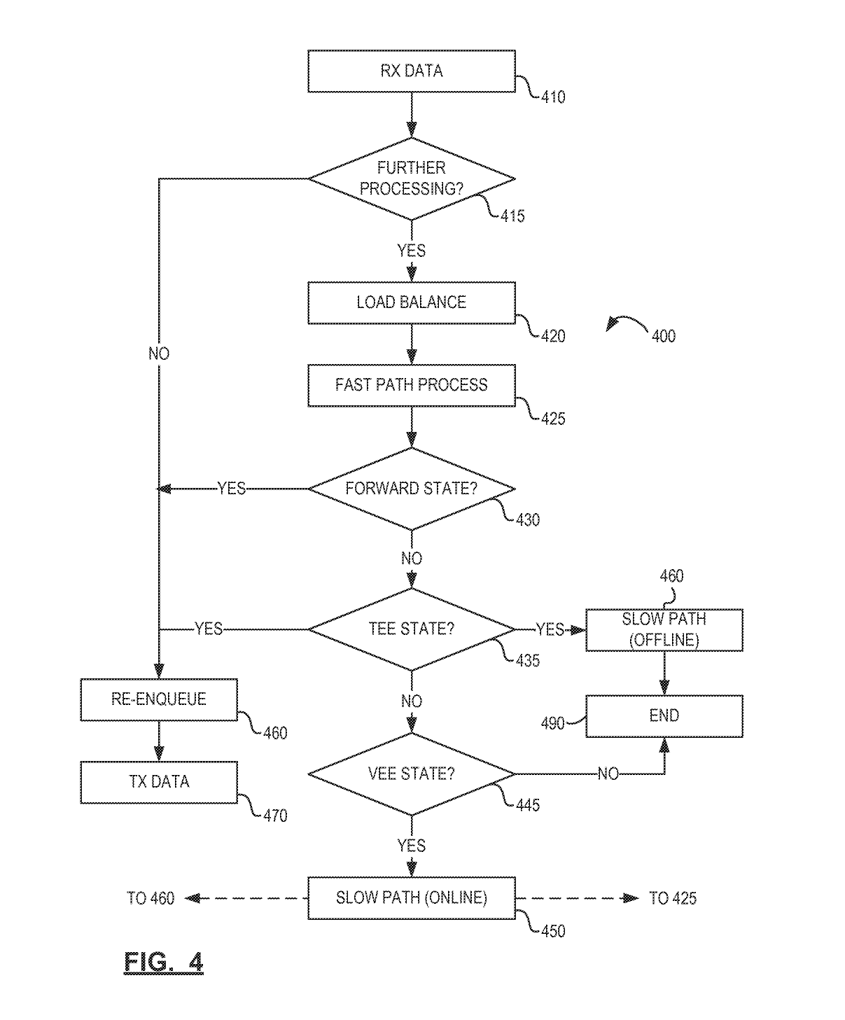

Referring now to FIG. 4, there is illustrated an example process flow that may be followed by a media service gateway, such as media service gateway 135 or 300.

Process flow 400 begins at 410 with receiving network data at 410, for example via an internal switching module 3105 of a switch element 310.

At 415, the media service gateway may determine whether a current intersection mode indicates that the data, such as a packet, should be processed further, or simply forwarded. If no further processing is required, the data is re-enqueued at 460.

Otherwise, at 420, a load balancer 3120 of switch element 310 may determine which packet processing element 330 is available to process the data. In embodiments without a load balancer, this action may be omitted and the data forwarded to any packet processing element 330 according to a suitable algorithm.

At 425, fast-path module 3360 of the selected packet processing element 330 may perform fast-path processing, as described herein.

If a current flow state is determined to be a forward state at 430, the data may be re-enqueued at 460.

If a current flow state is determined to be a tee state at 435, the data may be re-enqueued at 460 and also forwarded for further slow-path processing at 440 and, after processing, discarded or cached at 490. In the tee state, such slow-path processing may be performed offline and not in real-time, without engaging a timeout timer.

If a current flow state is determined to be a vee state at 445, the data may be forwarded for further slow-path processing at 450 by a slow-path module 3305, as described herein. In the vee state, a timer may be engaged to ensure that slow-path processing does not exceed a timeout period. This is to ensure that a maximum latency is not exceeded. Upon completion of slow-path processing, the processed data may be forwarded back to a fast-path module 3360 for further processing.

Re-enqueued data may be transmitted at 470.

The described methods and systems may enable network operators (e.g., carriers) to manage video data traffic for similar reasons as they manage other traffic. For example, a business reason to manage video data traffic is to ease capital and operating expenditures and to manage demand for bandwidth and thus slow required capacity increases.

Access control can be performed when congested, for example by limiting or denying client requests for media streams, to preserve QoE of in-progress sessions. Otherwise, all users may experience degraded media streaming sessions.

Similarly, client devices may be directed or forced to receive media streams that require less bandwidth (e.g., transcoded media streams), thus reducing bandwidth requirements.

Video data may also be marked or tagged for downstream QoS control, so that downstream schedulers can prioritize and potentially shape or drop lower priority traffic.

It will be appreciated that the described methods and systems can be applied selectively to media stream data, or to all data traffic in a network.

Through use of the described methods and systems, network operators may be able to monetize some or all of the video traffic on their networks. For example, some network operators may offer optimized video data plans, in which the user pays a fee to receive an assurance that a minimum QoE will be provided (e.g., during peak times). Similarly, service or tiered data plans may prioritize higher paying customers, including video customers, “power users”, or others.

Network operators may also employ the described methods and systems to satisfy service level agreements with third party content providers or CDNs, or to provide advertisement facilities.

In general, the described methods and systems allow network operators to optimize media traffic and tune individual media sessions in order to balance the overall quality of experience and network utilization. So-called “last mile” QoE can be optimized based on determinations made during the delivery of the media session, which in turn can be based on: network topology, capacity and status (e.g. congestion); device (and player) type and capabilities; subscriber profile and location; source content and quality; and subscriber or carrier policies (e.g., PCC policy).

On a larger scale, aggregate video QoE can be assessed to optimize a plurality of media sessions, for example over an entire cellular site. Such optimization can be applied to normalize QoE across all subscribers, devices, video formats or content sources, enabling a network operator to effectively manage a video pipe.

The network operator can apply access control, bitrate or session shaping and policy application, data tagging, dynamic transcoding/transrating, client video buffer management, URL redirection, stream replacement and stream switching.

As noted, the described systems and methods can be used to fulfill a video PCEF and AF role, with policy driven, video-aware optimization and service delivery through internal policies and integration with other PCC architectures, including meta-policy (e.g., policies based on subscriber tier or data plan, or knowledge of downstream policies so as not to conflict).

In some cases, the described methods and systems can be used to provide a transparent TCP proxy, to improve TCP performance over wireless channels, for example by enabling TCP SACK and header compression

The present invention has been described here by way of example only. Various modification and variations may be made to these exemplary embodiments without departing from the spirit and scope of the invention, which is limited only by the appended claims.

1-50. (canceled)

51. A method of optimizing data traffic destined for an external computing device in a network, the method comprising:
receiving data destined for the external computing device from the network;
identifying a selected media session in the received data;
processing the selected media session; and
transmitting the processed selected media session data to the external computing device via the network.

52. The method of claim 51, further comprising:
processing the received data in a fast path;
determining a current flow state;
if a current flow state indicates that further processing of the received data is to be performed, processing the data in a slow path, wherein the processing the data in the slow path identifies the selected media session.

53. The method of claim 52, wherein the fast path processing comprises packet marking after processing the selected media session data and prior to transmitting the processed selected media session data.

54. The method of claim 52, wherein the fast path processing comprises packet shaping or policing after processing the selected media session data and prior to transmitting the processed selected media session data.

55. The method of claim 51, wherein the selected media session is processed in accordance with at least one policy.

56. The method of claim 51, further comprising, prior to identifying the selected media session, load balancing between a plurality of packet processing elements to identify a packet processing element to process the received data.

57. The method of claim 51, further comprising estimating a traffic load of at least one network domain associated with the external computing device.

58. The method of claim 57, wherein an optimization applied when processing the selected media session is determined based at least on the estimated traffic load of the at least one network domain.

59. The method of claim 51, wherein an optimization applied when processing the selected media session comprises transcoding the input media stream.

60. An apparatus for optimizing data traffic destined for an external computing device in a network, the apparatus comprising:
a memory;
a network interface; and
at least one processor communicatively coupled to the memory and the network interface, the processor configured to:
receive data destined for the external computing device from the network;
identify a selected media session in the received data;
process the selected media session; and
transmit the processed selected media session data to the external computing device via the network.

61. A system for optimizing data traffic in a network, the system comprising:
a switch element configured to receive data destined for the external computing device from the network;
a packet processing element configured to:
identify a selected media session in the received data;
process the selected media session; and
wherein the switch element is further configured to transmit the processed data to the external computing device via the network.

62. The system of claim 61, wherein the packet processing element comprises:
a fast path module configured to process the received data and determine a current flow state; and
a slow path module configured to process the data to identify the selected media session if the current flow state indicates that further processing of the received data is to be performed.

63. The system of claim 62, wherein the slow path processing is performed inline.

64. The system of claim 62, wherein the fast path processing comprises packet marking after the selected media session data is processed and prior to transmission of the processed selected media session data.

65. The system of claim 62, wherein the fast path processing comprises packet shaping after the selected media session data is processed and prior to transmission of the processed selected media session data.

66. The system of claim 61, wherein the selected media session is processed in accordance with at least one policy.

67. The system of claim 61, wherein the switch element comprises a load balancer configured to load balance between a plurality of packet processing elements to identify a packet processing element to process the received data.

68. The system of claim 61, further comprising a control element, wherein the control element is configured to estimate a traffic load of at least one network domain associated with the external computing device.

69. The system of claim 68, wherein an optimization applied when processing the selected media session is determined based at least on the estimated traffic load level of the at least one network domain.

70. The system of claim 61, wherein an optimization applied when processing the selected media session comprises transcoding the input media stream.
